(19) United States
(12) Patent Application Publication
(10) Pub. No.: US 2013/0198022 A1
(43) Pub. Date: Aug. 1, 2013

(54) Method and Apparatus of Determining A Linked List of Candidate Products

(71) Applicant: Wei Zhang, Hangzhou (CN)

(72) Inventor: Wei Zhang, Hangzhou (CN)

(73) Assignee: ALIBABA GROUP HOLDING LIMITED, Grand Cayman (KY)

(21) Appl. No.: 13/381,822

(22) PCT Filed: Oct. 18, 2011
(86) PCT No.: PCT/US11/56720

§ 371 Date: Dec. 30, 2011

(30) Foreign Application Priority Data
Oct. 22, 2010 (CN) 201010527002.8

(51) Int. Cl. G06Q 30/06

(52) U.S. Cl. CPC G06Q 30/0601
USPC 705/26.1

(57) ABSTRACT

The present disclosure discloses a method of determining a linked list of candidate products. The method may provide a same product type set including a first product and a plurality of second products. For each second product of the same product type set, the method computes similarity scores between values of the first product and the second product with respect to each non-nominal attribute and each nominal attribute. The method may further computes a similarity score between the first product and the second product based on the similarity scores between the values of the first product and the second product with respect to each non-nominal attribute and each nominal attribute. In some embodiments, the method may render at least one second product which similarity score is among the top similarity scores with the first product as a linked list of candidate products for the first product.

### CROSS REFERENCE TO RELATED PATENT APPLICATIONS

This application is a national stage application of an international patent application PCT/US11/56720, filed Oct. 18, 2011, which claims priority to Chinese Patent Application No. 201010527002.8, filed on Oct. 22, 2010, entitled “Method and Related Apparatus of Determining a Linked List of Candidate Products,” which applications are hereby incorporated by reference in their entirety.

### TECHNICAL FIELD

The present disclosure relates to the field of computer network technology, and particularly, methods of determining a linked list of candidate products, methods of determining a similarity score between nominal attribute values of two products, apparatuses of determining a linked list of candidate products, and systems of providing a linked list of candidate products.

### BACKGROUND

Online shopping is an emerging shopping method. Having the advantages of diversity, convenience, promptness, time-saving, labor-saving and low pricing as compared with the traditional method of shopping, the online shopping has become a popular shopping method.

An online store operator uploads information of each product that is for sales to an e-commerce website. The information of a product includes a product identifier, an image, and values of attributes that are associated with the product.

Based on the characteristics of the values of attributes, the attributes may be classified into two categories: nominal attributes and non-nominal attributes. The non-nominal attributes include numerical attributes, ordinal attributes and set attributes.

A characteristic of the nominal attributes is that their attribute values are non-ordered character strings. For example, a product brand, which attribute value is a non-ordered character string, belongs to a nominal attribute. For example, a cosmetics product has a product brand attribute, which value includes Avon, Olay, Estee Lauder, Biotherm, or Lan Kou, etc. On the other hand, attribute values of non-nominal attributes are natural numbers or ordered character strings that correspond to natural numbers. For example, a price attribute associated with a product belongs to a numerical attribute, which attribute value corresponds to any real number greater than zero. For example, let the product be a particular type of shoes. The price of the shoes is $59.99. For another example, an attribute associated with sales volume of a product belongs to an ordinal attribute, which attribute value corresponds to any natural number or any other mapped forms of natural numbers such as ordered character strings—“high”, “medium” and “low”. Let's use the example of the particular type of shoes again for illustration. The sales volume of the shoes is 100 pairs. A product color belongs to a set attribute, which attribute value corresponds to a set formed from one or more elements in a predetermined enumerable set. Values of the colors of shoes include, for example, {violet, red, yellow}.

When a user conducts online shopping, a commonly seen process includes: logging into an e-commerce website through a client browser; obtaining various product information through such means as a search function provided by the e-commerce website, a recommended list of products or a sales product list of an online store operator that is previously bookmarked by the user; selecting a product based on the obtained information; and submitting a product order upon confirming to make a purchase.

In the above process, selecting a product and confirming to make a purchase by the user is based on information of various products are key procedures. In order to provide more information of related products to a user for comparison, an e-commerce website generally provides information of other candidate products that are close to or similar to a product selected by the user upon user selection of this product.

FIG. 1 shows a basic principle used in existing technologies for providing a list of candidate products that are close to or similar to a product selected by a user. Let product t be the product selected by the user. Procedure details are given as follows.

At 101, attribute values of attributes associated with each product, including attribute values of attributes associated with the product t and other products, are obtained from a product attribute information database.

At 102, a similarity score between the product t and each of the other products is computed based on the obtained attribute values of each product.

Use product c as an example. Based on the obtained values of attributes associated with the product c and values of corresponding attributes associated with the product t, a similarity score between the product c and the product t, Similarity(t, c), is computed as:

$$Similarity ( t , c ) = \frac{{\sum }_{i = 1 … n}^{ } {w}_{i} * {sim}_{i} ( t , c )}{{\sum }_{i = 1 … n} {w}_{i}}$$

The letter i is an identifier of an attribute. If each product has n attributes, the value of i ranges from 1 to n and tᵢ is the value of attribute i associated with the product t. cᵢ is the value of attribute i associated with product c. wᵢ is the weight for the attribute i. Simᵢ is a similarity score between the product t and the product c with respect to the attribute i.

At 103, products that have similarity scores greater than a predetermined threshold, dₛ, are selected to form a set of similar products C_{A} based on the similarity score between the user-selected product t and each product that is computed at 102.

At 104, products of the set of similar products C_{A} are arranged in a descending order of the similarity scores of the products and the product t, and a linked list including the first N predetermined number of top-ranked products is selected as a linked list of similar products for the product t.

At 105, related information of each product (e.g., an identifier of the product, an image, a description and comment, etc.) of the linked list of similar products that is determined at 104 is provided to the user.

Furthermore, prior to user selection of a product, an identifier of each product and a corresponding linked list of similar products of respective product may be stored in advance. After a user selects a product, a linked list of similar products for that product may be provided to the user based on an identifier of the product.

At the foregoing block 102, existing technologies use the following scheme to compute a similarity score for an attribute, Simᵢ, for different types of attributes of a product:

1. If attribute i is a numerical attribute, a similarity score between product t and product c with respect to the attribute i is:

$${Sim}_{i} ( {t}_{i} , {c}_{i} ) = 1 - \frac{D ( {t}_{i} , {c}_{i} ) - min D}{max D - min D} ,$$

where D (.) is a distance measurement. D(tᵢ, cᵢ)=|tᵢ−cᵢ|. min D corresponds to the minimum value among all distances between every two of the products with respect to the attribute i.

2. If attribute i is an ordinal attribute, a similarity score between product t and product c with respect to the attribute i is:

$${Sim}_{i} ( {t}_{i} , {c}_{i} ) = 1 - \frac{\vert {t}_{i} - {c}_{i} \vert}{( n - 1 )} ,$$

where n is an upper bound for associated ordinal number.

3. If attribute i is a set attribute, a similarity score between product t and product c with respect to the attribute i is:

$${Sim}_{i} ( {t}_{i} , {c}_{i} ) = 1 - \frac{\vert {t}_{i} ⋂ {c}_{i} \vert}{\vert {t}_{i} ⋃ {c}_{i} \vert} .$$

4. If attribute i is a nominal attribute, a similarity score between product t and product c with respect to the attribute i is:

$${Sim}_{i} ( {t}_{i} , {c}_{i} ) = \{ \begin{matrix}1 , & {t}_{i} = {c}_{i} \\ \frac{\vert s ( {t}_{i} , {c}_{i} ) - m \vert}{1 - m} , & {t}_{i} \neq {c}_{i}\end{matrix} \\ m = \frac{1}{1 + {( log \frac{N}{2} )}^{2}} ,$$

where N is the total number of the products.

$$s ( {t}_{i} , {c}_{i} ) = \frac{1}{1 + log \frac{N}{f ( {t}_{i} )} \times log \frac{N}{f ( {c}_{i} )}} ,$$

where f (tᵢ) and f (cᵢ) represent the numbers of occurrences of tᵢ and cᵢ as an attribute value for that attribute associated with products of a same product type set respectively.

s(.) is related to the numbers of occurrences of the attribute values tᵢ and cᵢ as the value for that nominal attribute among all the products. If the numbers of occurrences of these two attribute values are close to each other, e.g., both having a relatively high or low number of occurrences, the similarity score between these two attribute values is relatively high. Otherwise, the similarity score between these two attribute values is relatively low.

The log(N/f(.)) function is used to measure a distinctive or unusual feature of an attribute value. If the attribute value tᵢ occurs infrequently as an attribute value of a corresponding nominal attribute of products, the value of this function is relatively large. Otherwise, the value of this function is comparatively small if the frequency of occurrences is high.

The similarity score between tᵢ and cᵢ, Simᵢ (tᵢ, cᵢ), carries a meaning that is similar to s(.). However, in order to facilitate computation of a similarity score between two products, the range for the values of s(.) is normalized, i.e., the value range is adjusted to be [0, 1].

Currently, nominal attributes (e.g., a product brand attribute and a product name attribute, etc.) of a product constitute a large part of attributes associated with the product. Furthermore, a number of nominal attributes (e.g., a product brand) are important factors of consideration for users in selecting products. Therefore, when a similarity score between two products, Similarity(t, c), is computed, weights of nominal attributes (i.e., importance of the nominal attributes) are generally very high. Existing technologies compute a similarity score between nominal attribute values of two products through character string matching. Specifically, a similarity score is one when character strings associated with attribute values of two products for a nominal attribute are the same. Otherwise, the similarity score is computed based on statistical distribution of the character strings. This processing method of existing technologies fails to discover the semantic meaning of attribute values and correctly compute similarity scores for these important attributes (i.e., nominal attributes), thus failing to accurately provide candidate products for a product selected by a user.

### SUMMARY

Exemplary embodiments of the present disclosure provide a method of determining a linked list of candidate products to solve the problems of existing technologies that fail to accurately determine a similarity score between two products and hence fail to accurately provide a linked list of candidate products.

Correspondingly, the exemplary embodiments further provide a system of providing a linked list of candidate products and an apparatus of determining a similarity score between products with respect to a nominal attribute.

In one embodiment, the present disclosure provides a method of determining a linked list of candidate products. The method may provide a same product type set including a first product and a plurality of second products. For each second product of the same product type set, the method may compute a similarity score between values of the first product and the second product with respect to each non-nominal attribute.

Additionally, the method may further compute a similarity score between values of the first product and the second product with respect to each nominal attribute. If a value of a nominal attribute of the first product is different from a value of the nominal attribute of the second product, the method may determine a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

In some embodiments, the method may further compute a similarity score between the first product and the second product based on the similarity score between the values of the first product and the second product with respect to each non-nominal attribute and the similarity score between the values of the first product and the second product with respect to each nominal attribute. The method may render at least one second product which similarity score is among the top similarity scores with the first product as a linked list of candidate products for the first product.

In one embodiment, the present disclosure may further provide a method of determining a similarity score between values of two products with respect to a nominal attribute. During computation of a similarity score between values of a first product and a second product with respect to a nominal attribute, if the value of the nominal attribute of the first product is different from the value of the nominal attribute of the second product, the method may compute the similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

In one embodiment, the present disclosure may further provide an apparatus of determining a linked list of candidate products. The apparatus may include a provision unit configured to provide a same product type set including a first product and a plurality of second products. Additionally, the apparatus may further include a first similarity determination unit configured to compute a similarity score between values of the first product and a second product with respect to each non-nominal attribute for each second product of the same product type set.

In one embodiment, the apparatus may further include a second similarity determination unit configured to compute a similarity score between values of the first product and the second product with respect to each nominal attribute for each second product of the same product type set. If a value of a nominal attribute of the first product is different from a value of the nominal attribute of the second product, the second similarity determination unit may determine a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

In some embodiments, the apparatus may include a product similarity determination unit. The product determination unit is configured to compute a similarity score between the first product and the second product based on the similarity score between the values of the first product and the second product with respect to each non-nominal attribute that is determined by the first similarity determination unit and the similarity score between the values of the first product and the second product with respect to each nominal attribute that is determined by the second similarity determination unit. Additionally, the apparatus may further include a linked list determination unit configured to render at least one second product which similarity score is among the top similarity scores with the first product as a linked list of candidate products for the first product based on the similarity score between the first product and each second product that is determined by the product similarity determination unit.

In some embodiments, the present disclosure may further provide a system of providing a linked list of candidate products. The system may include a web server, a transaction record database, a product attribute database and an apparatus of determining a linked list of candidate products. In one embodiment, the web server may be configured to send a search request for candidate products to the apparatus of determining a linked list of candidate products. The request may include, for example, an identifier of a designated product. The transaction record database may be configured to store a user purchase record set. Furthermore, the product attribute database may be configured to store values of attributes associated with each product.

In one embodiment, the apparatus of determining a linked list of candidate products may determine a linked list of candidate product for each product based on the user purchase record set that is stored in the transaction record database and the values of the attributes associated with each product that are stored in the product attribute database. Furthermore, the apparatus may store a correspondence relationship between an identifier of each product and the linked list of candidate products of respective product. In response to receiving the search request for candidate products from the web server, the apparatus may select a linked list of candidate products corresponding to the identifier of the designated product that is included in the search request. In one embodiment, the apparatus may select the linked list of candidate products based on the stored correspondence relationships between identifiers of products and linked lists of candidate products, and provide the selected linked list of candidate products to the web server.

The exemplary embodiments improve an act of determining a similarity score between values of two products with respect to a nominal attribute during a process of determining a similarity score between the two products. Based on values of each product for the nominal attribute and records of products purchased by users as a whole, the exemplary embodiments determine whether a tendency of purchasing products having values of the nominal attribute that are consistent with an attribute value of a first product is similar to a tendency of purchasing products having values of the nominal attribute that are consistent with an attribute value of a second product for the whole user group. If similar, the exemplary embodiments determine that the similarity score between the attribute value of the nominal attribute of the first product and the attribute value of the nominal attribute of the second product is relatively high. Otherwise, the similarity score is relatively low. As a result, the exemplary embodiments can determine a similarity score based on the semantic meaning that is implicitly included in attribute values and thereby improve the accuracy of computing a similarity score between values of a nominal attribute.

### DESCRIPTION OF DRAWINGS

FIG. 1 shows a flowchart illustrating providing a linked list of candidate products in accordance with existing technologies.

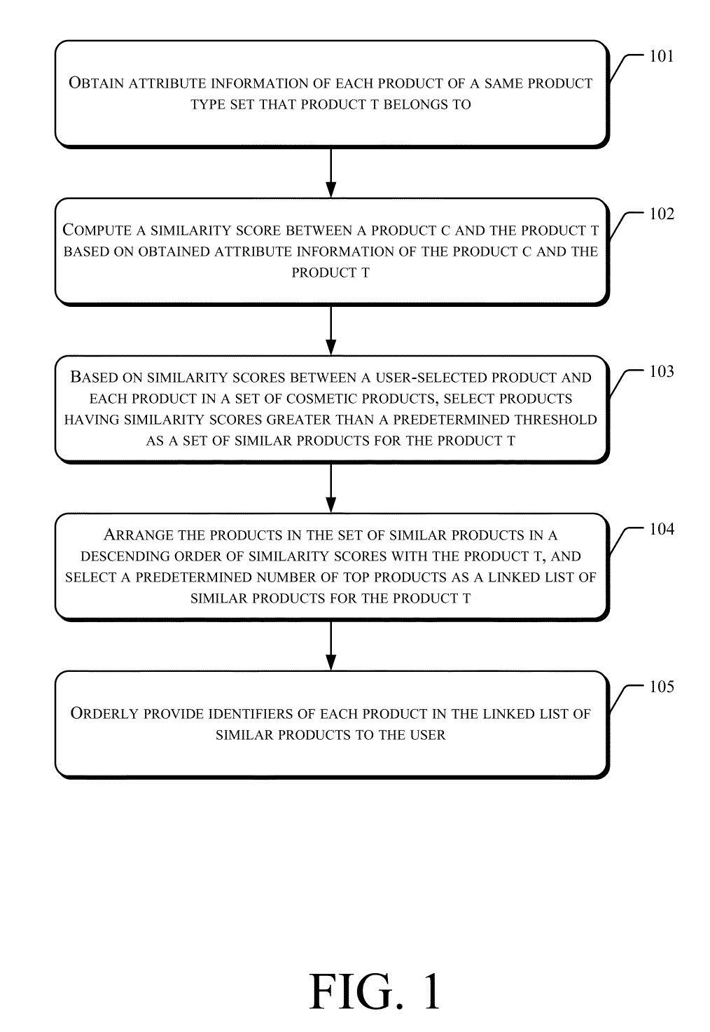

FIG. 2 shows a flowchart illustrating a core implementation principle in accordance with exemplary embodiments of the present disclosure.

FIG. 3a shows a structural diagram illustrating an exemplary system of providing a linked list of candidate products.

FIG. 3b shows a flowchart illustrating a process of providing a linked list of candidate products in accordance with the first exemplary embodiment of the present disclosure.

FIG. 4 shows a structural diagram illustrating an apparatus of determining a linked list of candidate products in accordance with the first exemplary embodiment of the present disclosure.

FIG. 5 shows a flowchart of computing a similarity score between attribute values of a product A and a product B with respect to a nominal attribute I in accordance with the first exemplary embodiment of the present disclosure.

FIG. 6a shows a schematic diagram illustrating a matrix of user attribute values in accordance with the first exemplary embodiment of the present disclosure.

FIG. 6b shows a schematic diagram illustrating respective column vectors corresponding to attribute values of nominal attributes of product A and product B in a matrix of user attribute values in accordance with the first exemplary embodiment of the present disclosure.

FIG. 7 shows a flowchart of determining a similarity score between nominal attribute values using a conditional probability approach in accordance with the first exemplary embodiment of the present disclosure.

FIG. 8 shows a structural diagram illustrating an apparatus of determining a linked list of candidate products in accordance with the second exemplary embodiment of the present disclosure.

FIG. 9 shows the exemplary apparatus described in FIGS. 4 and 8 in more detail.

### DETAILED DESCRIPTION

Inventors of this application have found that the reason why existing technologies fail to provide candidate products that are comparatively relevant to a user-selected product to the user is because a similarity score between values of two products with respect to a same nominal attribute is computed based on a hard computing paradigm. Specifically, a similarity score is determined based on respective frequencies of values of the two products for that nominal attribute within all the values of the products for that nominal attribute, and thus fails to discover semantic meaning that is implicitly included in the attribute values. For cosmetic products, for example, each product possesses a product brand attribute that is considered as a nominal attribute. A value of this attribute is a non-ordered character string. Let there exist such product brands as brand 1, brand 2, brand 3, brand 4, brand 5 and brand 6. Brand 1, brand 2 and brand 3 are premium brands while brand 4, brand 5 and brand 6 are low-end brands. “Brand 2” and “brand 5” cannot be rendered to have a high degree of similarity with each other even though respective frequencies of occurrences among attribute values of all products for this nominal attribute (i.e., the product brand) are close to each other. During computation of a similarity degree for the product brand attribute, products of premium brands have a higher similarity score therebetween while a similarity score between a product of a premium brand and a product of a low-end brand is lower.

A basic concept of the present disclosure is to improve computation of similarity scores for nominal attribute values when a similarity score between two products A (i.e., a first product) and B (i.e., a second product) is computed. Details of the concept are described as follows.

Based on user purchase records for products that have values consistent with respective values of the product A and the product B with respect to a nominal attribute for each nominal attribute, tendencies of a user group as a whole to purchase products regarding to the nominal attribute value of the product A (i.e., which users tend to purchase a product having a value of the nominal attribute consistent with the value of the nominal attribute of the product A, e.g., which users tend to purchase a product of brand “brand 2”) and the nominal attribute value of the product B (i.e., which users tend to purchase a product having a value of the nominal attribute consistent with the value of the nominal attribute of the product B, e.g., which users tend to purchase a product of brand “brand 5”) are determined. If the tendencies of the whole user group to purchase products regarding to respective nominal attribute values of the product A and the product B are alike, i.e., users who purchase a product of brand “brand 2” also purchase a product of brand “brand 5”, a degree of similarity between “brand 2” and “brand 5” is high with respect to this nominal attribute of product brand. Otherwise, the degree of similarity between “brand 2” and “brand 5” is low.

Based on the foregoing concept and methods of computing similarity scores for attribute values of other types of attributes, similarity scores between a product currently selected by a user and other products are determined A linked list of candidate products that is provided to the user is then determined based on the determined similarity scores.

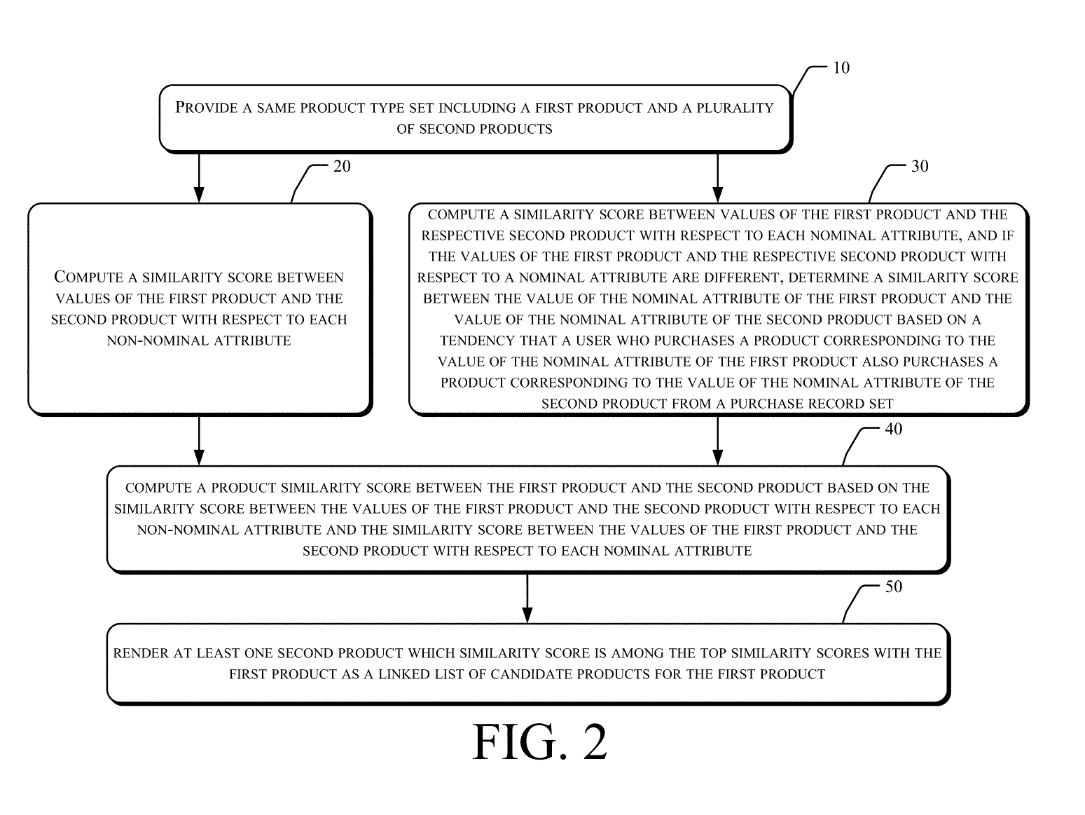

FIG. 2 shows a flowchart illustrating a core implementation principle in accordance with exemplary embodiments of the present disclosure.

At 10, the method provides a same product type set that includes a first product and a plurality of second products. For each second product in the same product type set, blocks 20-50 are performed.

At 20, the method computes a similarity score between values of the first product and a respective second product with respect to each non-nominal attribute.

At 30, the method computes a similarity score between values of the first product and the respective second product with respect to each nominal attribute. If the values of the first product and the respective second product with respect to a nominal attribute are different, the method determines a similarity score between the value of the nominal attribute of the first product and the value of the nominal attribute of the second product based on a tendency that a user who purchases a product corresponding to the value of the nominal attribute of the first product also purchases a product corresponding to the value of the nominal attribute of the second product from a purchase record set.

At 40, the method computes a product similarity score between the first product and the respective second product based on the similarity score between the values of the first product and the second product with respect to each non-nominal attribute and the similarity score between the values of the first product and the second product with respect to each nominal attribute.

At 50, the method renders at least one second product which similarity score is among the top similarity scores with the first product as a linked list of candidate products for the first product.

When a similarity score between two products with respect to each nominal attribute is determined during the process of computing similarity scores between values of nominal attributes of the two products at block 30, a similarity score between values of the first product and the second product with respect to a nominal attribute is set as the maximum defined value (e.g., one) if the values of the first product and the second product for the nominal attribute are the same.

Based on the foregoing principles of the present disclosure, two exemplary embodiments are described below to illustrate and explain the core implementation principles of methods disclosed in the present disclosure.

### First Embodiment

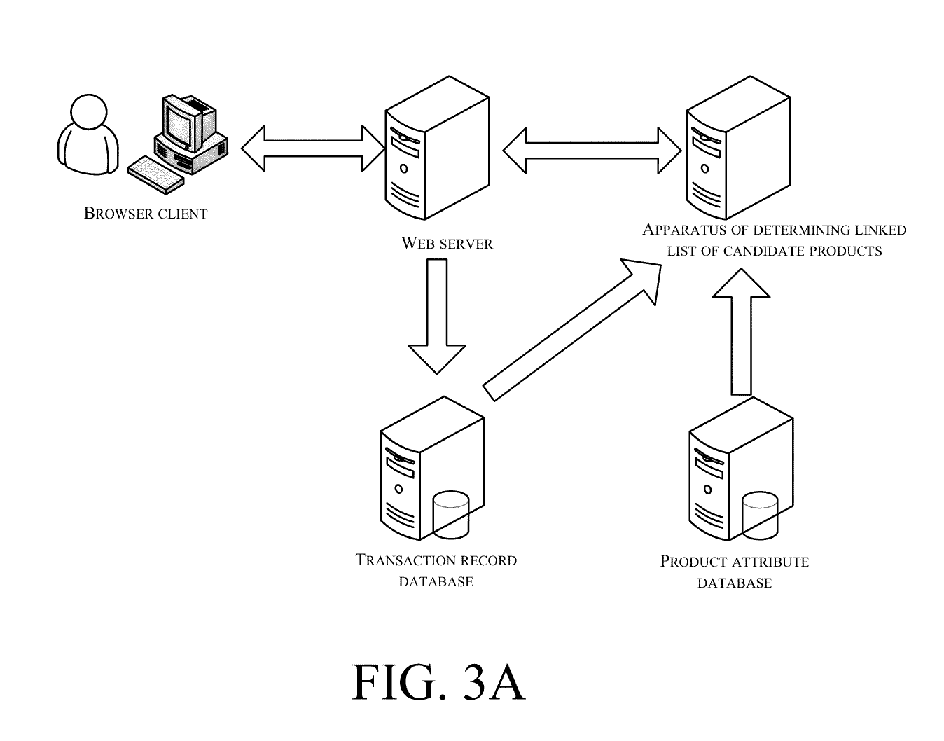

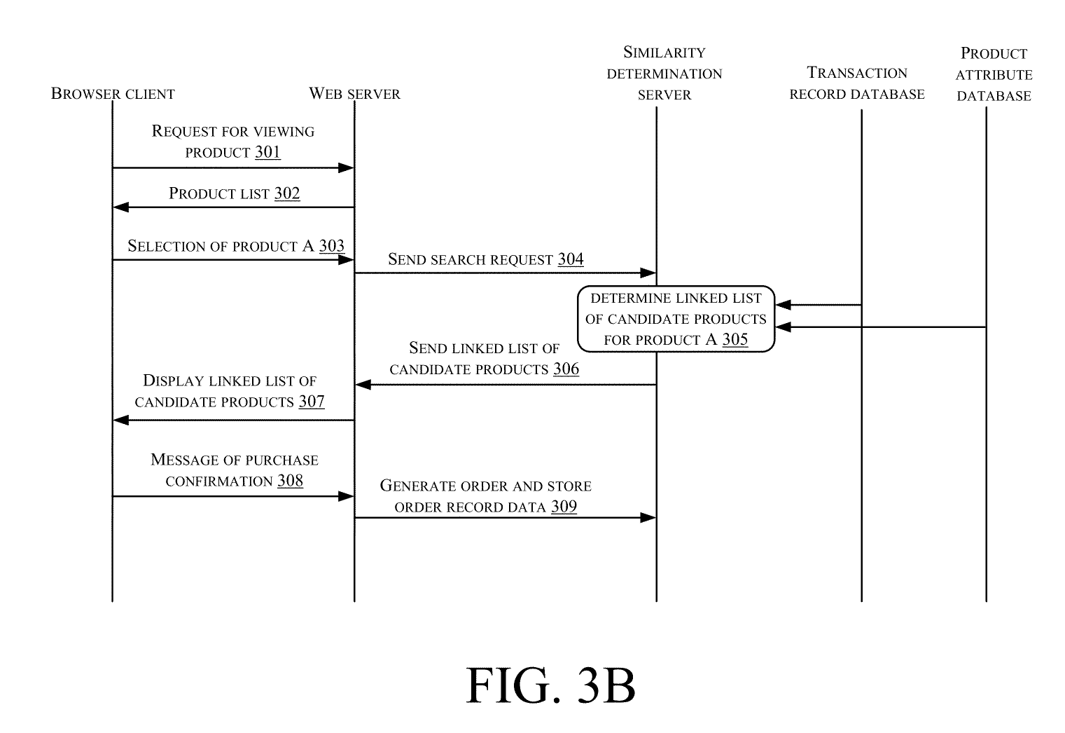

FIG. 3a shows a structural diagram illustrating an exemplary system 300 of providing a linked list of candidate products. The system includes a browser client 322, a web server 324, a transaction record database 326, a product attribute database 328, and server computer 330 that implements an apparatus of determining a linked list of candidate products.

A user may log into the web server 324 through the browser client 322 to view various pieces of product information, select products of interest, and confirm a product for purchase, etc. The web server 324 may send a search request for candidate products to the apparatus 330. The request may include, for example, an identifier of a designated product. In one embodiment, the transaction record database 326 may store data of order records for products purchased by users. Each order record include the time when an order is generated, an identifier of a user, identifier(s) of product(s) purchased by the user, number(s) of the product(s) purchased. The product attribute database 328 may store attribute values of attributes associated with each product.

In some embodiments, the apparatus 330 may determine similarity scores between a product and other products in a same product type set for each product in the same product type set. Further, the apparatus 330 may determine these similarity scores between the product and each of the other products based on similarity scores between attribute values of the product and each of the other products in the same product type set and respective predetermined weights associated with the attributes.

In one embodiment, the apparatus 330 may determine a linked list of candidate product for each product based on a user purchase record set that is stored in the transaction record database and the values of the attributes associated with each product that are stored in the product attribute database. Additionally, the apparatus may further store a correspondence relationship between an identifier and the linked list of candidate products of each product. In response to receiving the search request for candidate products from the web server, the apparatus 330 may select a linked list of candidate products corresponding to the identifier of the designated product that is included in the search request. The apparatus may select this linked list of candidate product from the stored correspondence relationships between the identifiers of products and respective linked lists of candidate products, and provide the selected linked list of candidate products to the web server.

When the similarity scores between the first product and the second products in the same product type set are determined, the apparatus may perform the following for each second product in the same product type set. In one embodiment, the apparatus computes a similarity score between values of the first product and the second product with respect to each non-nominal attribute. When a similarity score between values of the first product and the second product is computed with respect to each nominal attribute and if the value of a nominal attribute of the first product is different from the value of the nominal attribute of the second product, the apparatus may determine a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

In some embodiments, the apparatus 330 may further compute a similarity score between the first product and the second product based on the similarity score between the values of the first product and the second product with respect to each non-nominal attribute and the similarity score between the values of the first product and the second product with respect to each nominal attribute. In response to computing the similarity scores between the first product and each of the second products, the apparatus may render at least one second product which similarity score is among the top similarity scores with the first product as a linked list of candidate products for the first product.

An exemplary process of providing a linked list of candidate products to a user is shown in FIG. 3b.

At 301, the user communicates with the web server through the browser client and sends a product view request. The product view request may include different information. By way of example and not limitation, the product view request may include a request for viewing a list of recommended products, a request for searching product information based on a keyword, and/or a request for viewing a bookmarked list of products sold by an online store that is sent upon logging using a user name and a password, etc.

At 302, upon receiving the product view request, the web server sends a product list to the user. In one embodiment, the product list may include identifiers of products. Additionally or alternatively, the product list may further include thumbnail images of the products, brief descriptions, etc.

At 303, the user selects a product A from the product list that is provided by the web server through, for example, hovering a mouse over a thumbnail image of the product or clicking an identifier of the product, etc.

At 304, the web server sends a request for viewing candidate products to the apparatus of determining a linked list of candidate products. The request includes an identifier of product A that is selected by the user.

At 305, in response to receiving the request for viewing candidate products, the apparatus finds a linked list of candidate products (ListA: H-I-J) that corresponds to the identifier of the product A included in the request for viewing candidate products from pre-stored correspondence relationships between identifiers of products and linked lists of candidate products (as shown in Table 1). H, I, J, K, L, M, R, S, T and U in Table 1 are respective identifiers of other products. Table 1 shows an example of stored correspondence relationships between identifiers of products and respective linked lists of candidate products.

TABLE 1

| | Corresponding Linked List |
|---|---|
| Product Identifier | of Candidate Products |
| A | ListA: H-I-J |
| B | ListB: K-L-M |
| C | ListC: R-S-T-U |

The linked lists of candidate products in Table 1 are linked lists of candidate products generated by the apparatus in advance. Based on data stored in the transaction record database and the product attribute database, the apparatus computes similarity scores between the product A and other products, and adds products that are similarity scores with the product A greater than a predetermined threshold into a candidate product set C_{A}. In one embodiment, the apparatus may further arrange the products in C_{A} in a descending order of the similarity scores, and select a predetermined number of top-ranked products to generate a linked list of candidate products. In this example, the linked list of candidate products for the product A is List A: H-I-J.

In one embodiment, in order to increase the efficiency of computing a similarity score between two products, the products may be categorized in advance. Only similarity scores between the product A and other products in a same product type set that the product A belongs to are computed. For example, if the product A that is selected by the user is body lotion of brand 5, only similarity scores between the product A (i.e., body lotion of brand 5) and other products in a cosmetic product set are needed to be computed.

At 306, the apparatus sends the found linked list of candidate products, ListA: H-I-J, to the web server.

At 307, the web server displays the linked list of candidate products that is sent from the apparatus to the user through the browser client.

At 308, the user confirms a product to be purchased based on the displayed linked list of candidate products. Upon confirming to make the purchase, the user sends a message of purchase confirmation to the web server. This message of purchase confirmation may include, for example, an identifier of the product that is confirmed to be purchased.

At 309, upon receiving the message of purchase confirmation, the web server generates an order and stores a purchase record of the user in the transaction record database.

At the foregoing block 306, the apparatus may directly send the linked list of candidate products to the browser client for display to the user, i.e. without relaying through the web server to skip block 307.

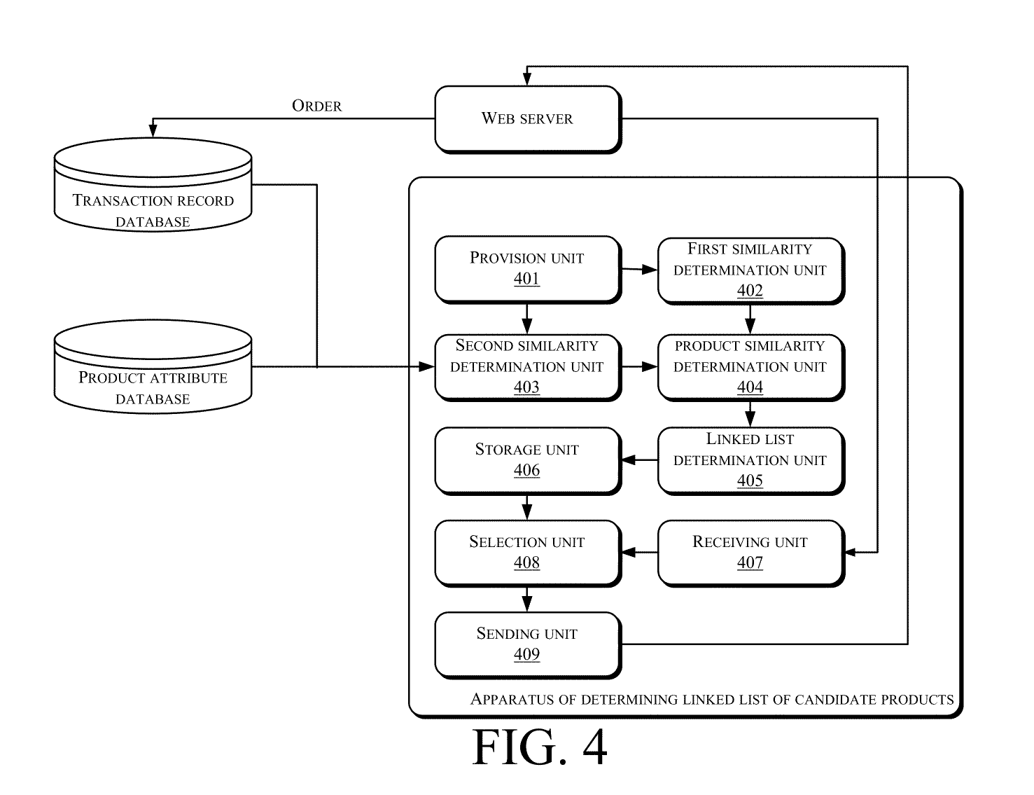

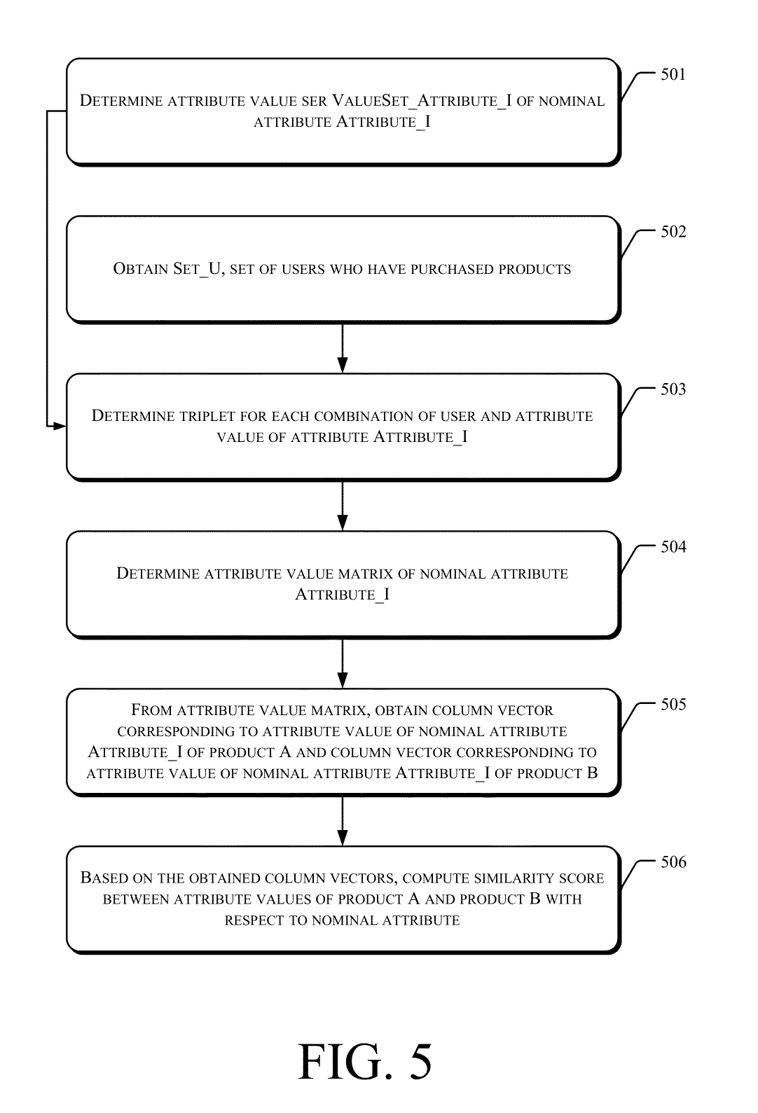

FIG. 4 shows a structural diagram illustrating the apparatus of determining a linked list of candidate products at the foregoing block 305. When a linked list of candidate products is determined, the apparatus first computes similarity scores between attribute values of each product (e.g., product A) in a same product type set and other products (e.g., product B) in the same product type set with respect to each attribute. The apparatus computes a similarity score between the product A and the product B based on the similarity scores between attribute values of the product A and the product B, for example. Various blocks of FIG. 5 of the present disclosure are used for illustrating the improvements of computing similarity scores between nominal attribute values of two products. The methods of computing similarity scores between attribute values for non-nominal attributes (such as numerical attributes, ordinal attributes and set attributes) are similar to those of existing technologies, and are therefore not redundantly described herein.

An example is described herein to illustrate the computation of a similarity score between values of the product A and the product B with respect to a nominal attribute that has an identifier as Attribute_I.

At 501, the method determines a value set, ITEM, for the nominal attribute, Attribute_I, based on respective values of various products that are stored in the product attribute database for the nominal attribute, Attribute_I.

A data table of the product attribute database, Table_P, stores values of attributes of each product. A storage structure of the data table, Table_P, is shown in Table 2. Each row includes respective values of various attributes of a same product. Each column includes respective values of various products for a same attribute. Alternatively, it may be understood that values of different attributes of a product are separately stored in different fields of a same row.

TABLE 2

| | Attribute Identifier | | | |
|---|---|---|---|---|
| | Nominal | Nominal | Numerical | |
| Product | Attribute | Attribute | Attribute | Set Attribute |
| Identifier | Attribute_I | Attribute_W | Attribute_X | Attribute_Y |
| A | ITEM₁ | W1 | 1 | Blue, Violet |
| B | ITEM₂ | W2 | 3 | Violet, |
| | | | | Green, Red |
| C | ITEM₃ | W2 | 6 | Green |
| D | ITEM₃ | W2 | 2 | Yellow |
| E | ITEM₂ | W2 | 5 | Red, White |
| F | ITEM₁ | W1 | 8 | White |
| . . . | . . . | . . . | . . . | . . . |

By using a SQL statement “Select distinct Attribute_I from Table_P” for a database search, different attribute values of the fields corresponding to the attribute Attribute_I may be obtained from the table Table_P. Hence, an attribute value set (i.e., ValueSet_Attribute_I={ITEMᵢ}, where i=0, . . . , N) of the attribute Attribute_I, which includes N elements, is obtained. In this specific example, the attribute value set, ValueSet_Attribute_I, includes three different values: ITEM₁, ITEM₂, ITEM₃.

At 502, the method obtains, Set_U, a set of users who have purchased a product from the transaction record database.

Table 3 shows an example of a storage structure of an order data table, Table_T, in the transaction record database. Different fields in each row separately store various relevant data of an order record, including the time when an order is generated, an identifier of a user, identifier(s) of product(s) purchased by the user, number(s) of products purchased, etc. For example, the third row of Table 3, which order record having a serial number of 55, indicates that a user who has an identifier of u₁₀₀ purchased a single product that has a product identifier of A at 18:00 on Jan. 4, 2007.

TABLE 3

| Order | | User | Product | |
|---|---|---|---|---|
| Number | Time | Identifier | Identifier | Quantity |
| No. | (Time) | (User) | (Product) | (Quantity) |
| . . . | . . . | . . . | . . . | . . . |
| 55 | 2007-1-4(18:00:00) | ^{u}100 | A | 1 |
| 56 | 2007-1-4(19:00:00) | ^{u}101 | B | 1 |
| . . . | . . . | . . . | . . . | . . . |

In the above-mentioned Table_T, user is the field that stores a user identifier. By using a SQL statement “Select distinct user from Table_T” for a database search, different user identifiers (e.g., u₁₀₀, u₁₀₁) in the user field may be obtained from the table Table_T. A user identifier set, Set_U={u₁₀₀, u₁₀₁}, may therefore be obtained.

Preferably, purchase behavior of users is considered. Specifically, users who have a habit of online shopping usually conduct online shopping daily or monthly. Behavior of this type of users possesses certain habitual or propensity characteristics. Some users may occasionally purchase products online once in two or three years. Behavior of this type of users possesses a high degree of eventuality and is difficult to observe any propensity. Therefore, order records of users of the former type are comparatively more useful. Given the consideration of reducing amount of data and improving processing efficiency, filtering may further be applied to select users who conduct online shopping within a predetermined time interval, e.g., users who conduct online shopping within one month, one season, half year or one year, etc., from the user identifier set Set_U.

At 503, the method determines a triplet [symbol] uᵢ, itemⱼ, 1/0 [symbol] for each combination of a user identifier and an attribute value of the attribute Attribute_I, based on the attribute value set ValueSet_Attribute_I obtained at block 501 and the user identifier set Set_U obtained at block 502. If a user who has a user identifier of uᵢ has purchased a product that has an attribute value of the attribute Attribute_I as itemⱼ, the value of the third vector element is one (or a first predetermined value), i.e., [symbol] uᵢ, itemⱼ, 1 [symbol] . Otherwise, the value of the third vector element in the property triplet is zero (or a second predetermined threshold), i.e., [symbol] uᵢ, itemⱼ, 0 [symbol] .

Each user identifier is sequentially obtained from the user identifier set Set_U to construct a triplet for the user identifier and a respective attribute value of the attribute Attribute_I. Below illustrates processes that are performed for two kinds of triplet construction methods.

Scheme 1: All records having a user identifier as uᵢ are obtained from the order data table Table_T. From the product identifier field in the obtained records, a set of identifiers of products (i.e., Pᵤ_{ᵢ}) which have been purchased by the user of user identifier as uᵢ, may be obtained. Respective values of the attribute Attribute_I of each product in the set Pᵤ_{ᵢ} may be obtained from the product attribute database. From the product attribute database, the attribute values of products in the set Pᵤ_{ᵢ} are obtained. The value of the third vector element is set to be one for a triplet in which the first vector element corresponds to uᵢ and the second vector element corresponds to a value of the attribute Attribute_I of a product in Pᵤ_{ᵢ}. The value of the third vector element is set to be zero for a triplet in which the first vector element corresponds to uᵢ and the second vector element corresponds to a value of the attribute Attribute_I (which is within the attribute value set ValueSet_Attribute_I) that is different from the values of the attribute Attribute_I of the products that have been purchased by the user of user identifier as uᵢ. As such, N triplets corresponding to each combination of a user identifier uᵢ and an attribute value included in the attribute value set ValueSet_Attribute_I is obtained.

Scheme 2: Each attribute value itemₖ is sequentially obtained from the attribute value set, ValueSet_Attribute_I, where k ranges from 0 to N (number of elements included in the attribute value set, ValueSet_Attribute_I). The following SQL statement is executed.

Select *

From Table_T and Table_P

Where T.user=“uᵢ” and T.product=P.product and P.Attribute_I=“itemₖ”

If a return value of the above statement is not null, this indicates that the user uᵢ has purchased product(s) with respective value(s) of the nominal attribute Attribute_I as itemₖ. The third vector element is set to be one for a triplet in which the first vector element is uᵢ and the second vector element is itemₖ, i.e., [symbol] uᵢ, itemₖ, 1 [symbol] . Otherwise, the third vector element is set to be zero for a triplet in which the first vector element is uᵢ and the second Vector element is itemₖ, i.e., [symbol] uᵢ, itemₖ, 0 [symbol] .

At 504, the method determines a user attribute value matrix for the nominal attribute Attribute_I based on corresponding N triplets for the nominal attribute Attribute_I of the users determined at block 503. Each row of the user attribute value matrix includes information about whether products purchased by a same user possess various attribute values in the attribute value set ValueSet_Attribute_I. Each column of the matrix includes information about whether products purchased by various users possess a same attribute value in the attribute value set ValueSet_Attribute_I.

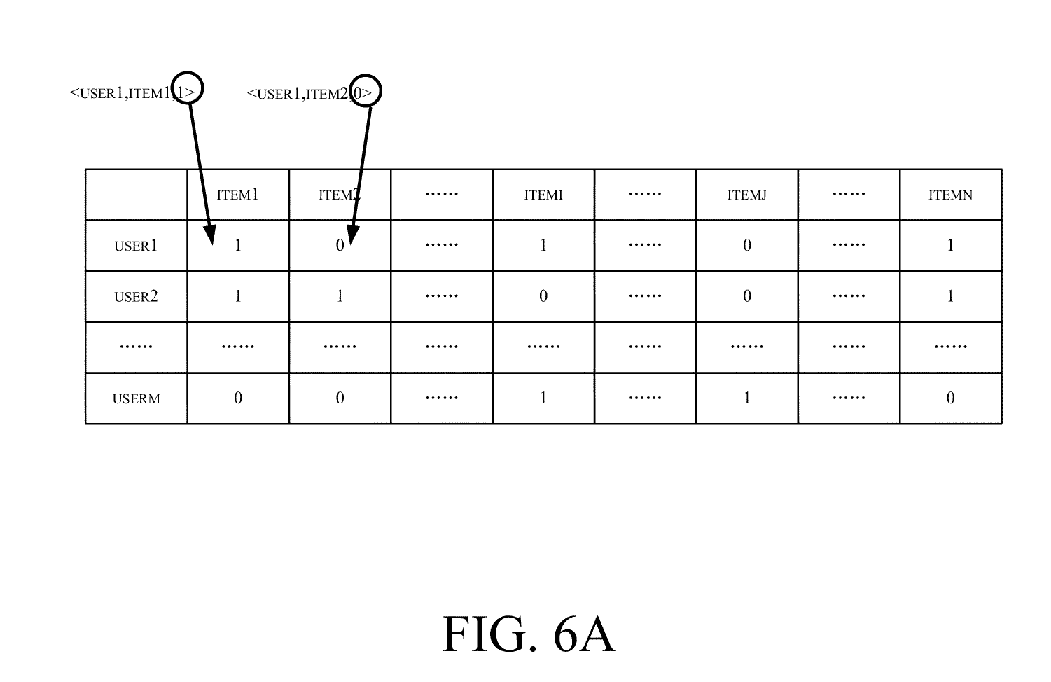

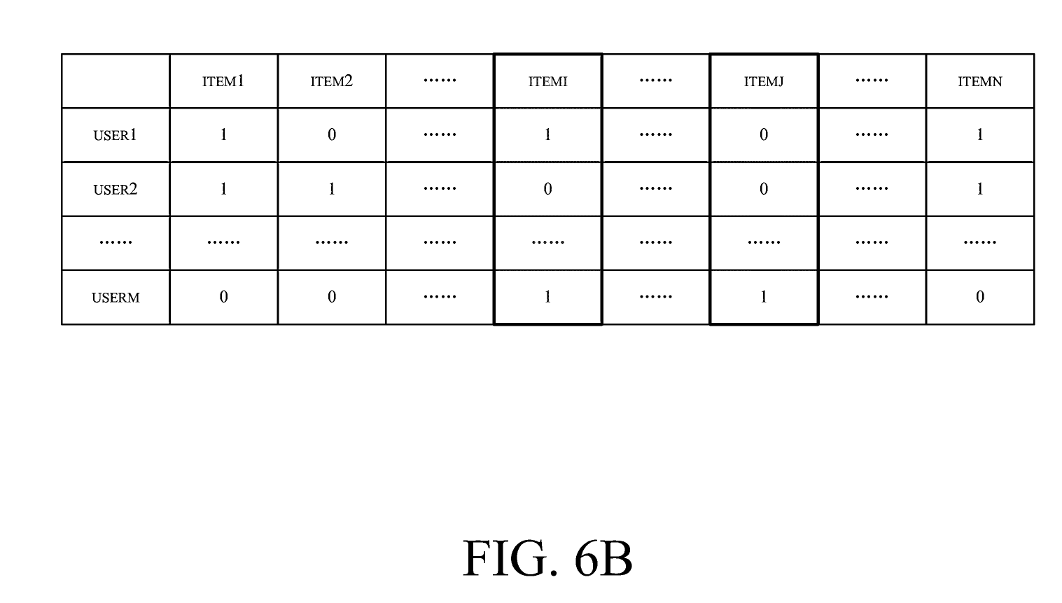

As shown in FIG. 6a, according to an order of the attributes that is set in the attribute value set ValueSet_Attribute_I, the third vector elements of the N triples corresponding to a same user are inputted into different positions of the same row of the user attribute value matrix.

At 505, based on the attribute value matrix obtained at block 504, the method obtains a column vector \vec{R}_{*,i} (that corresponds to an attribute value itemᵢ of the nominal attribute Attribute_I of the product A) and a column vector \vec{R}_{*,j} (that corresponds to an attribute value itemⱼ of the nominal attribute Attribute_I of the product B) as indicated by a thick line box in FIG. 6b. In this example, \vec{R}_{*,i}= [symbol] 1, 0, . . . , 1 [symbol] and \vec{R}_{*,j}= [symbol] 0, 0, . . . , 1 [symbol] .

The column vector \vec{R}_{*,i} represents a tendency of the entire user group to purchase products having attribute values of the nominal attribute Attribute_I as itemᵢ, i.e., which users tend to purchase a product having an attribute value of the nominal attribute Attribute_I as itemᵢ. The column vector \vec{R}_{*,j} represents a tendency of the entire user group to purchase products having attribute values of the nominal attribute Attribute_I as itemⱼ, i.e., which users tend to purchase a product having an attribute value of the nominal attribute Attribute_I as itemⱼ.

At 506, the method computes a mutual relevancy score between \vec{R}_{*,i} and \vec{R}_{*,j} that are obtained at block 505, and renders the computed mutual relevancy score to be a similarity score for values of the product A and the product B with respect to the nominal attribute Attribute_I, simᵢ(itemᵢ, itemⱼ).

$${sim}_{i} ( {item}_{i} , {item}_{j} ) = cos ( {\vec{R}}_{* , i} , {\vec{R}}_{* , j} ) = \frac{{\vec{R}}_{* , i} * {\vec{R}}_{* , j}}{{‖ {\vec{R}}_{* , i} ‖}_{2} {‖ {\vec{R}}_{* , j} ‖}_{2}}$$

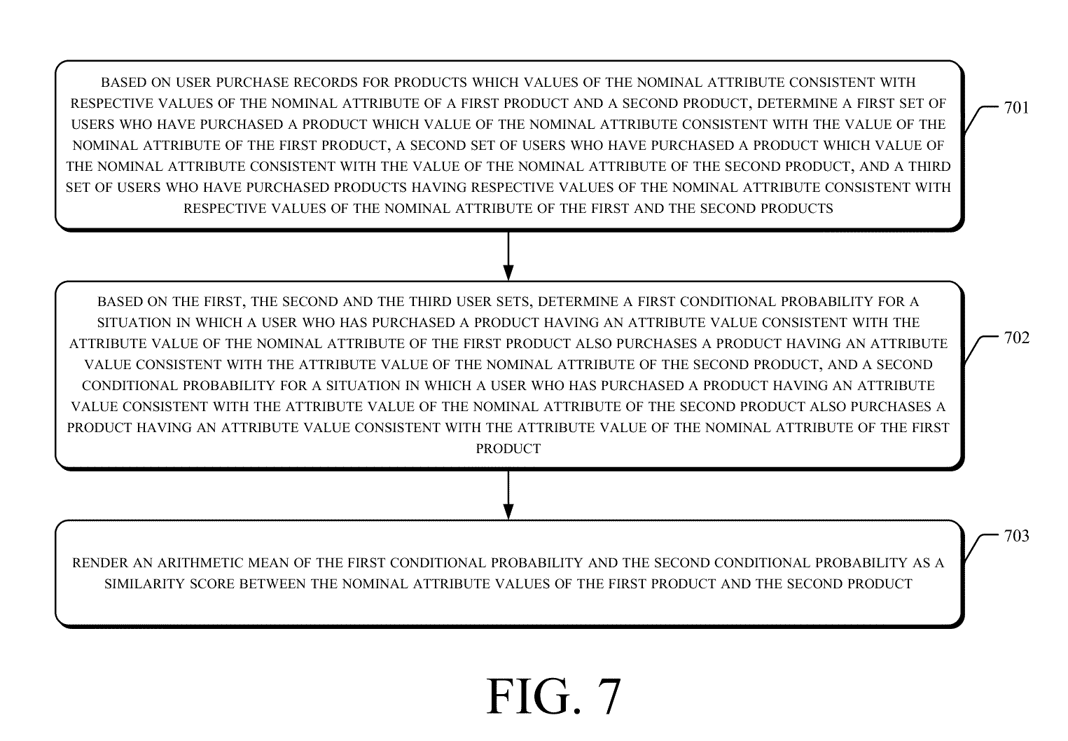

It should be noted that, instead of using the method of computing mutual relevancy at block 506, a method using conditional probability may alternatively be used to determine a similarity score between values of the product A and the product B with respect to the nominal attribute Attribute_I, simᵢ(itemᵢ, itemⱼ). Details of this process are given in FIG. 7.

At 701, based on user purchase records for products which values of the nominal attribute consistent with respective values of the nominal attribute of a first product and a second product, the method determines a first set of users who have purchased a product which value of the nominal attribute consistent with the value of the nominal attribute of the first product, a second set of users who have purchased a product which value of the nominal attribute consistent with the value of the nominal attribute of the second product, and a third set of users who have purchased products having respective values of the nominal attribute consistent with respective values of the nominal attribute of the first and the second products.

Based on the i^{th} column and j^{th} column in FIG. 6b, the present embodiment can obtain a set of users, U_{A}, who have purchased a product having an attribute value of the nominal attribute Attribute_I as itemᵢ (i.e., a set formed by users who correspond to elements in \vec{R}_{*,i} which element values are one), a set of users, U_{B}, who have purchased a product having an attribute value of the nominal attribute Attribute_I as itemⱼ (i.e., a set formed by users who correspond to elements in \vec{R}_{*,j} which element values are one), and a set of users, U_{AB}, who have purchased a product having an attribute value of the nominal attribute Attribute_I as itemᵢ and a product having an attribute value of the nominal attribute Attribute_I as itemⱼ.

At 702, based on the first, the second and the third user sets, the method determines a first conditional probability and a second conditional probability. The first conditional probability is a conditional probability for a situation in which a user who has purchased a product having an attribute value consistent with the attribute value of the nominal attribute of the first product also purchases a product having an attribute value consistent with the attribute value of the nominal attribute of the second product. The second conditional probability is a conditional probability for a situation in which a user who has purchased a product having an attribute value consistent with the attribute value of the nominal attribute of the second product also purchases a product having an attribute value consistent with the attribute value of the nominal attribute of the first product.

Based on the user set U_{A} and the user set U_{AB}, a conditional probability for a situation in which a user who has purchased a product having an attribute value as itemᵢ also purchases a product having an attribute value as itemⱼ is determined to be:

P(B|A)=|U_{AB}|/|U_{A}|, where |U| is the number of elements included in a set U.

Similarly, a conditional probability for a situation in which a user who has purchased a product having an attribute value as itemⱼ also purchases a product having an attribute value as itemᵢ is determined to be:

P(A|B)=|U_{AB}|/|U_{B}|

At 703, the method renders an arithmetic mean of the first conditional probability and the second conditional probability as a similarity score between the nominal attribute values of the first product and the second product.

A similarity score, simᵢ(itemᵢ, itemᵢ), between the attribute value itemᵢ of the nominal attribute Attribute_I of the product A and the attribute value itemⱼ of the nominal attribute Attribute_I of the product B is determined to be:

simᵢ(itemᵢ,itemⱼ)=(P(B|A)+P(A|B))/2

In other words, if users of a user group who have purchased products that have attribute values of the nominal attribute Attribute_I as itemᵢ have a high tendency of purchasing products that have attribute values of the nominal attribute Attribute_I as itemⱼ, the attribute value itemᵢ and the attribute value itemⱼ are highly similar to each other.

Understandably, FIG. 7 only describes a scheme of accurately computing a similarity score between two products with respect to a nominal attribute. Rendering the first conditional probability and the second conditional probability directly as similarity scores can also resolve the problem of failing to discover a semantic meaning that is implicitly included in attribute values.

As shown in FIG. 4, the apparatus of determining a linked list of candidate products includes a provision unit 401, a first similarity determination unit 402, a second similarity determination unit 403, a product similarity determination unit 404 and a linked list determination unit 405. Preferably, the apparatus may further include a storage unit 406, a receiving unit 407, a selection unit 408 and a sending unit 409.

The provision unit 401 is configured to provide a same product type set including a first product and a plurality of second products.

The first similarity determination unit 402 is configured to compute a similarity score between values of the first product and a second product with respect to each non-nominal attribute for each second product of the same product type set.

The second similarity determination unit 403 is configured to compute a similarity score between values of the first product and the second product with respect to each nominal attribute for each second product of the same product type set. If a value of a nominal attribute of the first product is different from a value of the nominal attribute of the second product, the second similarity determination unit 402 may determine a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

The product similarity determination unit 404 is configured to compute a similarity score between the first product and the second product based on the similarity score between the values of the first product and the second product with respect to each non-nominal attribute that is determined by the first similarity determination unit 402 and the similarity score between the values of the first product and the second product with respect to each nominal attribute that is determined by the second similarity determination unit 403.

The linked list determination unit 405 is configured to render at least one second product which similarity score is among the top similarity scores with the first product as a linked list of candidate products for the first product based on the similarity score between the first product and each second product that is determined by the product similarity determination unit 404.

The storage unit 406 is configured to store a correspondence relationship between an identifier of the first product and the linked list of candidate products that is determined by the linked list determination unit 405.

The receiving unit 407 is configured to receive a search request for candidate products.

The selection unit 408 is configured to, in response to receiving the search request for candidate products by the receiving unit 407, select a linked list of candidate products corresponding to an identifier of a product that is included in the search request from correspondence relationships between identifiers of products and linked lists of candidate products that are stored in the storage unit 406.

The sending unit 409 is configured to send the linked list of candidate product obtained by the selection unit 408 to the web server.

Details of a process of computing similarity scores between nominal attribute values of product A and other products B by the second similarity determination unit 403 can be referenced to FIGS. 5-7, and therefore are not redundantly described herein.

When determining a similarity score between attribute values of the product A and the product B for a particular nominal attribute, the present embodiment determines whether respective tendencies of values of that nominal attribute of the products purchased by the entire user group are similar with respect to attribute values of the product A and the product B, based on attribute values of each product with respect to that nominal attribute and product purchase records of each user. If similar, this indicates that the degree of similarity between the attribute values of the product A and the product B for that nominal attribute is high. Otherwise, the similarity between the attribute values of the product A and the product B for that nominal attribute is low. Therefore, the semantic meaning that is implicitly included in the similarity score between the attribute values of the product A and the product B for that nominal attribute can be discovered. This overcomes the problem of existing technologies and improves the accuracy of computing similarity scores for nominal attribute values, thus improving the accuracy of computing a linked list of candidate products.

### Second Embodiment

The first embodiment provides an offline method of providing a linked list of candidate products for a selected product A. The first embodiment computes similarity scores between the product A and other products, provides a linked list of candidate products based on the computed similarity scores between the selected product A and the other products, stores correspondence relationships between identifiers and respective linked lists of candidate products of each product, in response to receiving a search request for candidate products, selects a linked list of candidate products corresponding to a product identifier included in the search request from a correspondence relationship between that product identifier and corresponding linked list of candidate products, and provide the selected linked list of candidate products to a web server. This method stores correspondence relationships between identifiers of products and respective linked lists of candidate products of those products in advance, thus occupying certain system resources. Parts of these correspondence relationships may, however, have a low probability of being searched for. As a result, the present disclosure further provides an online method of determining a linked list of candidate products. Specifically, the apparatus at block 305 does not select a linked list of candidate products corresponding to a product identifier included in a search request for candidate products from the stored correspondence relationships between identifiers and linked lists of candidate products of each product. Rather, the apparatus computes the linked list of candidate products corresponding to the product identifier included in the search request for candidate products based on the data in transaction record database and the product attribute database in real time.

This real-time computation method of a linked list of candidate products may consume a relatively large amount of time when similarity scores are computed if the number of other products in the same product type set is relatively large. If the apparatus at block 305 receives a relatively large number of search requests for candidate products from the web server within a relatively short period of time, the processing workload will increase. Given the above consideration, filtering may therefore be preferably performed in advance for attributes other than nominal attributes. If a similarity score between attribute values of a designated product A (which corresponds to a product identifier included in a search request for candidate products) and another product B is less than a respective predetermined threshold with respect to an attribute (e.g., a numerical attribute, etc) other than nominal attributes, similarity scores between attribute values of the product A and the product B for the nominal attributes are no longer needed to be computed. The product B is immediately excluded from the candidate product set C_{A}.

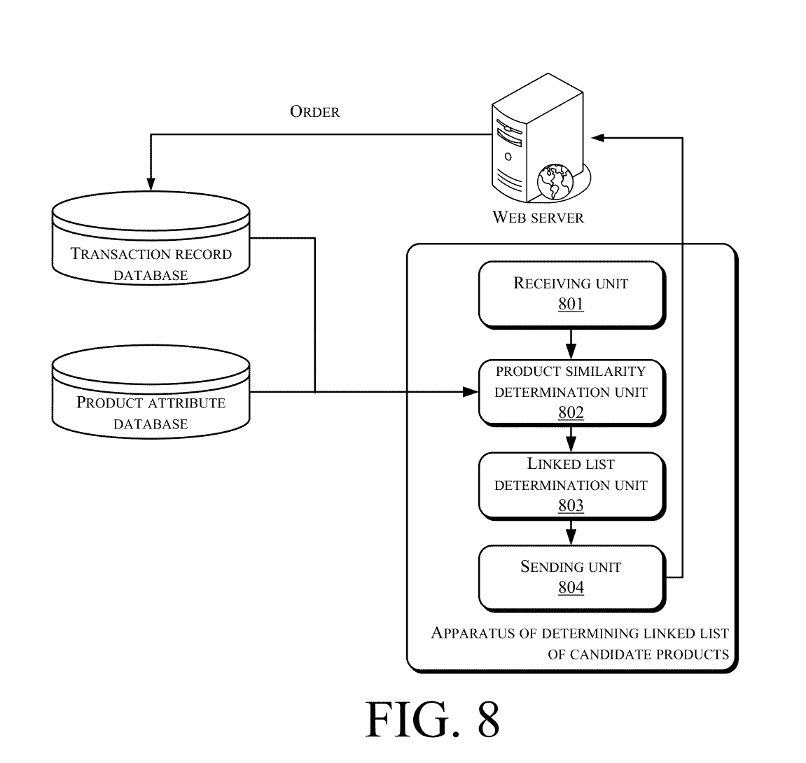

FIG. 8 shows a structural diagram illustrating an exemplary apparatus of determining a linked list of candidate products. The apparatus includes a receiving unit 801, a product similarity determination unit 802, a linked list determination unit 803 and a sending unit 804.

The receiving unit 801 is configured to receive a search request for candidate products from a web server.

The product similarity determination unit 802 is configured to, for a designated product corresponding to a product identifier included in the search request, determine a similarity score between the designated product and each of other products in a same product type set that the designated product belongs to based on similarity scores between values of attributes of the designated product and the respective product and predetermined weights for the attributes. When determining a similarity score between attribute values of the designated product and each of the other products with respect to each nominal attribute, if the attribute values between the designated product and a respective one of the other products with respect to a nominal attribute are different, the product similarity determination unit 802 may determine the similarity score between the value of the nominal attribute of the first product and the value of the nominal attribute of the respective one of the other products based on a tendency that a user who purchases a product corresponding to the value of the nominal attribute of the first product purchases a product corresponding to the value of the nominal attribute of the respective one of the other products from a set of purchase records.

The linked list determination unit 803 is configured to render at least one other product which similarity score is among the top similarity scores with the designated product as a linked list of candidate products for the designated product.

The sending unit 804 is configured to send the linked list of candidate products obtained by the linked list determination unit 803 to the web server.

One of ordinary skills in the art can understand all or part of the process in the above exemplary methods may be achieved by using a computer program to instruct relevant hardware. The program may be stored in computer-readable storage media, e.g., ROM/RAM, a magnetic disk, an optical disk, etc.

The disclosed method, apparatus and system may be used in an environment or in a configuration of universal or specialized computer system(s). Examples include a personal computer, a server computer, a handheld device or a portable device, a tablet device, a multi-processor system, a microprocessor system, a set-top box, programmable consumer electronics, a network PC, a micro-computer, a macro-computer, and a distributed computing environment including any system or device above.

The disclosed method, apparatus and system can be described in the general context of computer-executable instructions, e.g., program modules. Generally, the program modules can include routines, programs, objects, components, data structures, and the like that perform particular functions or implement particular abstract data types. The disclosed method, apparatus and system can also be practiced in a distributed computing environment where functions are performed by remote processing devices that are linked through a communication network. In a distributed computing environment, the program modules may be located in local and/or remote computer storage media, including memory storage devices.

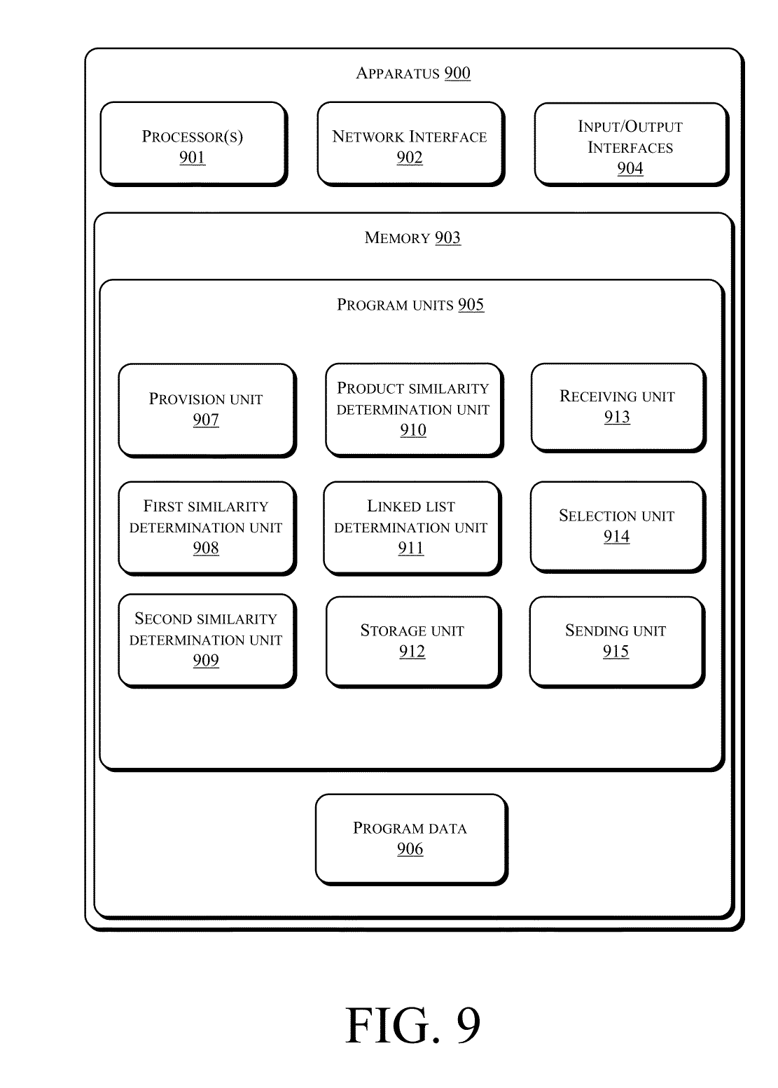

For example, FIG. 9 illustrates an exemplary apparatus 900, such as the apparatus as described above, in more detail. In one embodiment, the apparatus 900 can include, but is not limited to, one or more processors 901, a network interface 902, memory 903, and an input/output interface 904.

The memory 903 may include computer-readable media in the form of volatile memory, such as random-access memory (RAM) and/or non-volatile memory, such as read only memory (ROM) or flash RAM. The memory 903 is an example of computer-readable media.

Computer-readable media includes volatile and non-volatile, removable and non-removable media implemented in any method or technology for storage of information such as computer readable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 903 may include program units 905 and program data 906. In one embodiment, the program units 905 may include a provision unit 907, a first similarity determination unit 908, a second similarity determination unit 909, a product similarity determination unit 910, and a linked list determination unit 911. Additionally or alternatively, in some embodiments, the program units 905 may further include a storage unit 912, a receiving unit 913, a selection unit 914 and a sending unit 915. Details about these program units may be found in the foregoing embodiments described above.

Understandably, one skilled in the art may alter or modify the disclosed methods, systems and apparatuses in many different ways without departing from the spirit and the scope of this disclosure. Accordingly, it is intended that the present disclosure covers all modifications and variations which fall within the scope of the claims of the present disclosure and their equivalents.

What is claimed is:

1. A method of determining a linked list of candidate products, comprising:
providing a same product type set including a first product and a plurality of second products;
for each second product of the same product type set,
computing a similarity score between values of the first product and the second product with respect to each non-nominal attribute, and
computing a similarity score between values of the first product and the second product with respect to each nominal attribute, wherein:
if a value of the nominal attribute of the first product is different from a value of the nominal attribute of the second product, determining a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set;
computing a similarity score between the first product and the second product based on the similarity score between the values of the first product and the second product with respect to each non-nominal attribute and the similarity score between the values of the first product and the second product with respect to each nominal attribute; and
rendering at least one second product which similarity score is among top similarity scores with the first product as a linked list of candidate products for the first product.

2. The method of claim 1, wherein the determining a similarity score comprises:
determining a first user set, a second user set, and a third user set based on the purchase record set, wherein:
the first user set corresponds to a set of users in the product record set who have purchased a product having a value of the nominal attribute consistent with the value of the nominal attribute of the first product;
the second user set corresponds to a set of users in the product record set who have purchased a product having a value of the nominal attribute consistent with the value of the nominal attribute of the second product; and
the third user set corresponds to a set of users in the product record set who have purchased products having respective values of the nominal attribute consistent with the value of the nominal attribute of the first product and the value of the nominal attribute of the second product respectively.

3. The method of claim 2, further comprising, based on the first user set, the second user set and the third user set:
determining a first conditional probability for a situation in which the users who have purchased the product having the value of nominal attribute consistent with the value of the nominal attribute of the first product further purchased a product having a value of the nominal attribute consistent with the value of the nominal attribute of the second product, and
determining a second conditional probability for a situation in which the users who have purchased the product having the value of nominal attribute consistent with the value of the nominal attribute of the second product purchased a product having a value of the nominal attribute consistent with the value of the nominal attribute of the first product.

4. The method of claim 3, further comprising rendering an arithmetic mean of the first conditional probability and the second conditional probability as the similarity score between the first product and the second product with respect to the nominal attribute.

5. The method of claim 1, wherein the determining a similarity score comprises:
determining a user attribute value relationship matrix for the nominal attribute based on the purchase record set, each column of the user relationship matrix representing whether products having a same value for the nominal attribute have been purchased by users.

6. The method of claim 5, wherein the determining a similarity score further comprises:
selecting, from the user attribute value relationship matrix, a column \vec{R}_{*,i} that corresponds to the value of the nominal attribute of the first product as a user purchase record for the products having the values of the nominal attribute consistent with the value of the nominal attribute of the first product, and a column \vec{R}_{*,j} that corresponds to the value of the nominal attribute of the second product as a user purchase record for the products having the values of the nominal attribute consistent with the value of the nominal attribute of the second product, wherein the similarity score, sim(i, j), between the first product and the second product is
$$sim ( i , j ) = cos ( {\vec{R}}_{* , i} , {\vec{R}}_{* , j} ) = \frac{{\vec{R}}_{* , i} * {\vec{R}}_{* , j}}{{‖ {\vec{R}}_{* , i} ‖}_{2} {‖ {\vec{R}}_{* , j} ‖}_{2}} .$$

7. The method of claim 5, wherein determining the user attribute value relationship matrix for the nominal attribute based on the purchase record set comprises:
for each purchase record of a user in the user purchase record set,
determining values of the nominal attribute of products that were purchased by the user based on the purchase record of the user and respective values of the nominal attribute of each product,
based on the determined values of the nominal attribute of the products that were purchased by the user, determining a vector \vec{R}_{m,*} of the nominal attribute associated with the user, wherein m is an identifier of the user, and for each element R_{m,i} of \vec{R}_{m,*} wherein i is an identifier of a value in a value set, if the user has purchased a product that has the identifier of the value as i, a value for the element R_{m,i} is set as a first value, otherwise, the value of the element R_{m,i} is set as a second value; and
rendering the vector of the nominal attribute associated with each user as a row in the matrix to determine the user attribute value relationship matrix of the nominal attribute.

8. The method of claim 1, wherein computing the similarity score between the values of the first product and the second product with respect to each nominal attribute further comprises:
if the value of the nominal attribute of the first product is the same as the value of the nominal attribute of the second product, setting the similarity score between the value of the nominal attribute of the first product and the value of the nominal attribute of the second product to be a maximum defined value.

9. The method of claim 1, wherein after rendering the at least one second product which similarity score is among the top similarity scores with the first product as the linked list of candidate products for the first product, the method further comprises:
storing a correspondence relationship between an identifier of the first product and the determined linked list of candidate products.

10. A method of determining a similarity score between values of two products with respect to a nominal attribute, the method comprising:
computing a similarity score between values of a first product and a second product with respect to a nominal attribute, wherein:
if the value of the nominal attribute of the first product is different from the value of the nominal attribute of the second product, determining the similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set.

11. The method of claim 10, wherein the determining comprises:
determining a user attribute value relationship matrix for the nominal attribute based on the purchase record set, each column of the user relationship matrix representing whether

[symbol]

12. The method of claim 11, wherein the determining further comprises:
selecting, from the user attribute value relationship matrix, a column \vec{R}_{*,i} that corresponds to the value of the nominal attribute of the first product as a user purchase record for the products having the values of the nominal attribute consistent with the value of the nominal attribute of the first product, and a column \vec{R}_{*,j} that corresponds to the value of the nominal attribute of the second product as a user purchase record for the products having the values of the nominal attribute consistent with the value of the nominal attribute of the second product, wherein the similarity score, sim(i, j), between the first product and the second product is
$$sim ( i , j ) = cos ( {\vec{R}}_{* , i} , {\vec{R}}_{* , j} ) = \frac{{\vec{R}}_{* , i} * {\vec{R}}_{* , j}}{{‖ {\vec{R}}_{* , i} ‖}_{2} {‖ {\vec{R}}_{* , j} ‖}_{2}} .$$

13. The method of claim 11, wherein the determining further comprises:
determining a first user set, a second user set and a third user set based on the purchase record set, wherein:
the first user set corresponds to a set of users in the product record set who have purchased a product having a value of the nominal attribute consistent with the value of the nominal attribute of the first product;
the second user set corresponds to a set of users in the product record set who have purchased a product having a value of the nominal attribute consistent with the value of the nominal attribute of the second product;
the third user set corresponds to a set of users in the product record set who have purchased products having respective values of the nominal attribute consistent with the value of the nominal attribute of the first product and the value of the nominal attribute of the second product respectively;
based on the first user set, the second user set and the third user set,
determining a first conditional probability for a situation in which the users who have purchased the product having the value of nominal attribute consistent with the value of the nominal attribute of the first product further purchased a product having a value of the nominal attribute consistent with the value of the nominal attribute of the second product, and
determining a second conditional probability for a situation in which the users who have purchased the product having the value of nominal attribute consistent with the value of the nominal attribute of the second product purchased a product having a value of the nominal attribute consistent with the value of the nominal attribute of the first product; and
rendering an arithmetic mean of the first conditional probability and the second conditional probability as the similarity score between the first product and the second product with respect to the nominal attribute.

14. An apparatus of determining a linked list of candidate products, comprising:
a provision unit configured to provide a same product type set including a first product and a plurality of second products;
a first similarity determination unit configured to compute a similarity score between values of the first product and a second product with respect to each non-nominal attribute for each second product of the same product type set;
a second similarity determination unit configured to compute a similarity score between values of the first product and the second product with respect to each nominal attribute for each second product of the same product type set, and when a value of the nominal attribute of the first product is different from a value of the nominal attribute of the second product, determine a similarity score between the value of the nominal attribute of the first product and the value of the nominal attribute of the second product based on a tendency that a user who purchases a product corresponding to the value of the nominal attribute of the first product purchases a product corresponding to the value of the nominal attribute of the second product from a purchase record set;
a product similarity determination unit configured to compute a similarity score between the first product and the second product based on the similarity score between the values of the first product and the second product with respect to each non-nominal attribute that is determined by the first similarity determination unit and the similarity score between the values of the first product and the second product with respect to each nominal attribute that is determined by the second similarity determination unit; and
a linked list determination unit configured to render at least one second product which similarity score is among the top similarity scores with the first product as a linked list of candidate products for the first product based on the similarity score between the first product and each second product that is determined by the product similarity determination unit.

15. The apparatus of claim 14, further comprising:
a storage unit configured to store a correspondence relationship between an identifier of the first product and the linked list of candidate products that is determined by the linked list determination unit;
a receiving unit configured to receive a search request for candidate products; and
a selection unit configured to, in response to receiving the search request for candidate products by the receiving unit, select a linked list of candidate products corresponding to an identifier of a product that is included in the search request from correspondence relationships between identifiers of products and linked lists of candidate products that are stored in the storage unit.

16. The apparatus of claim 14, wherein the second similarity determination unit is further configured to set the similarity score between the value of the nominal attribute of the first product and the value of the nominal attribute of the second product to be a maximum defined value if the value of the nominal attribute of the first product is the same as the value of the nominal attribute of the second product.

17. A system of providing a linked list of candidate products, comprising:
a web server configured to send a search request for candidate products to an apparatus for determining a linked list of candidate products, the request including an identifier of a designated product;
a transaction record database configured to store a user purchase record set;
a product attribute database configured to store values of attributes associated with each product; and
the apparatus of determining a linked list of candidate products being configured to:
determine a linked list of candidate product for each product based on the user purchase record set that is stored in the transaction record database and the values of the attributes associated with each product that are stored in the product attribute database;
store a correspondence relationship between an identifier of each product and the linked list of candidate products of respective product;
in response to receiving the search request for candidate products from the web server, select a linked list of candidate products corresponding to the identifier of the designated product that is included in the search request from the stored correspondence relationships between identifiers of products and linked lists of candidate products; and
provide the selected linked list of candidate products to the web server.
